(19) United States
(12) Patent Application Publication
(10) Pub. No.: US 2015/0324724 A1
(43) Pub. Date: Nov. 12, 2015

(54) BENCHMARKING PERFORMANCE OF A SERVICE ORGANIZATION

(71) Applicant: International Business Machines Corporation, Armonk, NY (US)

(72) Inventors: Gargi B. Dasgupta, Gurgaon (IN); Thomas J. Lubeck, Raleigh, NC (US); George E. Stark, Austin, TX (US); Rodney B. Wallace, Silver Spring, MD (US)

(73) Assignee: International Business Machines Corporation, Armonk, NY (US)

(21) Appl. No.: 14/270,406

(22) Filed: May 6, 2014

(51) Int. Cl. G06Q 10/06

(52) U.S. Cl. CPC G06Q 10/06393

(57) ABSTRACT

A method and associated systems for benchmarking performance of a service organization. A processor collects recorded performance data that identifies how much time members of randomly selected service teams of the service organization required to perform tasks associated with sub-activities of an activity of interest. The data is sorted by sub-activity and data associated with certain biasing types of tasks may be discarded. For each sub-activity for which enough valid data exists, a sub-activity benchmark is identified as a function of a median of task-performance times associated with that sub-activity. This sub-activity benchmark may be used to derive statistical functions that characterize performance of another service team when performing tasks related to the same sub-activity. Such characterizations may be aggregated and exported to a scorecard report that identifies overperforming and underperforming service teams.

### TECHNICAL FIELD

The present invention relates to analyzing and benchmarking performance of a service organization.

### BACKGROUND

It may be difficult to benchmark performance of a service organization that performs a specific type of activity. If a manager attempts to compare performance to an ad hoc standard based on the manager's personal judgment, on an opinion of an other person with business knowledge, or on an average value derived from a small sample, results may be biased, may compare performance to a standard that cannot always be met or that is otherwise inappropriate, may not help the manager predict future performance, or may not provide information that supports development of best practices.

### BRIEF SUMMARY

A first embodiment of the present invention provides a method for benchmarking performance of a service organization, the method comprising:

a processor of a computer system selecting a set of service teams of a service organization, wherein each team of the set of service teams performs a plurality of service tasks, wherein a first task of the plurality of tasks is associated with a first sub-activity of a set of sub-activities and with a first task type of a set of task types;

the processor receiving a first set of performance records, wherein a first record of the first set of performance records comprises a first performance time that identifies a first duration of time needed by a first service team of the set of service teams to perform the first task;

the processor organizing the first set of performance records into a plurality of subsets of records, such that a first subset of records of the plurality of subsets comprises records that are associated with the first sub-activity;

the processor specifying a first benchmark of a first sub-activity of the first set of sub-activities as a function of a median value of all performance times comprised by the first subset of records.

A second embodiment of the present invention provides a computer program product, comprising a computer-readable hardware storage device having a computer-readable program code stored therein, the program code configured to be executed by a processor of a computer system to implement a method for benchmarking performance of a service organization, the method comprising:

the processor selecting a set of service teams of a service organization, wherein each team of the set of service teams performs a plurality of service tasks, wherein a first task of the plurality of tasks is associated with a first sub-activity of a set of sub-activities and with a first task type of a set of task types;

the processor receiving a first set of performance records, wherein a first record of the first set of performance records comprises a first performance time that identifies a first duration of time needed by a first service team of the set of service teams to perform the first task;

the processor organizing the first set of performance records into a plurality of subsets of records, such that a first subset of records of the plurality of subsets comprises records that are associated with the first sub-activity;

the processor specifying a first benchmark of a first sub-activity of the first set of sub-activities as a function of a median value of all performance times comprised by the first subset of records.

A third embodiment of the present invention provides a computer system comprising a processor, a memory coupled to the processor, and a computer-readable hardware storage device coupled to the processor, the storage device containing program code configured to be run by the processor via the memory to implement a method for benchmarking performance of a service organization, the method comprising:

the processor selecting a set of service teams of a service organization, wherein each team of the set of service teams performs a plurality of service tasks, wherein a first task of the plurality of tasks is associated with a first sub-activity of a set of sub-activities and with a first task type of a set of task types;

the processor receiving a first set of performance records, wherein a first record of the first set of performance records comprises a first performance time that identifies a first duration of time needed by a first service team of the set of service teams to perform the first task;

the processor organizing the first set of performance records into a plurality of subsets of records, such that a first subset of records of the plurality of subsets comprises records that are associated with the first sub-activity;

the processor specifying a first benchmark of a first sub-activity of the first set of sub-activities as a function of a median value of all performance times comprised by the first subset of records.

### BRIEF DESCRIPTION OF THE DRAWINGS

FIG. 1 shows the structure of a computer system and computer program code that may be used to implement a method for benchmarking performance of a service organization in accordance with embodiments of the present invention.

FIG. 2 is a flow chart that shows an embodiment of the method of the present invention that identifies a median-based standard for benchmarking performance of a service organization.

FIG. 3 is a flow chart showing an embodiment of the method of the present invention that uses a median-based benchmark to benchmark performance of a skill group or other type of service team of a service organization.

### DETAILED DESCRIPTION

Measuring performance of a service-delivery team, or of a skill group that specializes in one or more types of activities, may require comparing a duration of time required by the team to perform a specific service task against a standard or benchmark time. Identifying a meaningful, unbiased, and objective benchmark may, however, be difficult. An arbitrary standard based on a manager's personal experience, on an expert opinion, or an average from a small sample may produce biased results.

Embodiments of the present invention comprise statistical methods that select an initial benchmark value as a function of a median value—not an average value or a mean value—of randomly selected historic performance data, filtering the results in a novel way, applying the benchmark to performance of comparable service tasks, and dynamically adjusting the benchmark in response to these applications.

Such embodiments may produce benchmarking results that more accurately characterize performance of a service team when that team performs certain classes of activities and sub-activities. In some environments, for example, a “skill group” service team may handle some or all tasks related to a class of sub-activities within a certain range of handling times, but a few large, “outlying,” handling times may fall outside that range. Here, a benchmark value based on an average value of all handling times may be biased too high if there are too few outlying times to significantly affect the average. The result might be a performance standard that is too difficult for service groups to attain on a regular basis.

The present invention comprises a method that instead bases an initial benchmark value on a median value of the entire range of values, including outliers (that is, a value of a 50th percentile, or center point between the lowest value and the greatest outlying value), in order produce more useful benchmarks. This range is further adjusted by revising zero values to nonzero values in order to properly scale the resulting median-based benchmark and to remove potentially biasing effects of zero-valued anomalies that, because they do not represent real-world handling times, might bias a median-based benchmark value.

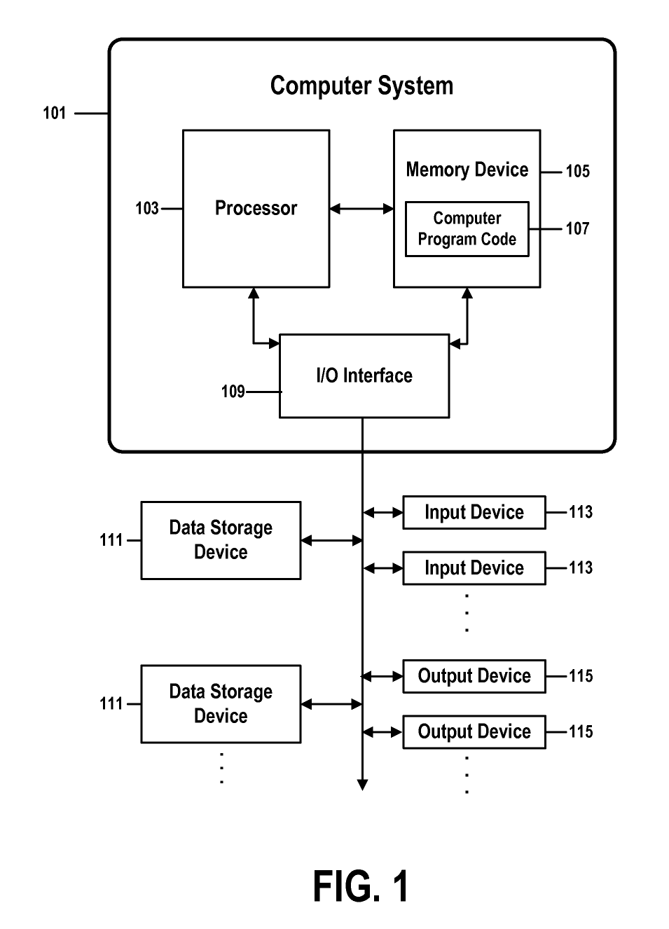

FIG. 1 shows a structure of a computer system and computer program code that may be used to implement a method for benchmarking performance of a service organization in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for benchmarking performance of a service organization in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for benchmarking performance of a service organization.

Any of the components of the present invention could be created, integrated, hosted, maintained, deployed, managed, serviced, supported, etc. by a service provider who offers to facilitate a method for benchmarking performance of a service organization. Thus the present invention discloses a process for deploying or integrating computing infrastructure, comprising integrating computer-readable code into the computer system 101, wherein the code in combination with the computer system 101 is capable of performing a method for benchmarking performance of a service organization.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

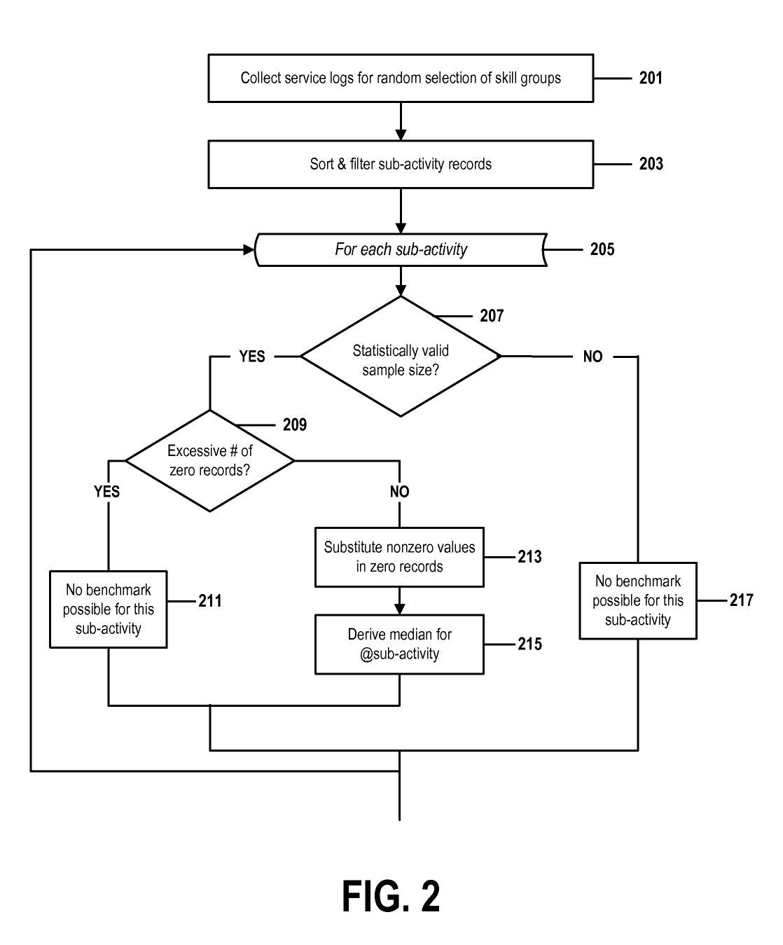

FIG. 2 is a flow chart that shows an embodiment of the method of the present invention that identifies a median-based standard for benchmarking performance of a service organization. FIG. 2 comprises steps 201-217.

In step 201, a processor of a computer or an other entity selects a random sample of historic performance data from which methods of the present invention will derive an initial value of a benchmark standard.

In the embodiment shown herein, this performance data comprises task-handing times of service-delivery teams (such as a skill group that specializes in one or more types of activities) of a service organization, wherein each task-handling time identifies how long it took a team to perform a particular task, and wherein each task may be associated with a sub-activity of an activity.

Thus, the universe of historic data from which the sample of performance data is selected in such embodiments may characterize how long it has taken service teams of a service organization to perform tasks related to sub-activities of an activity. More general embodiments may comprise a universe of data that describes performance of multiple service organizations, teams that perform different sets of sub-activities or activities for different service organizations, or that describes performance data related to handling sub-activities of more than one activity. In general, the present invention should not be construed to be constrained to a certain organizational structures or scope of service.

In one example, a universe of data might describe an international service organization that comprises forty national service teams, wherein each team manages service requests from a particular country. Each of these teams acts as a skill group that may perform any sub-activity comprised by a first activity of a plurality of activities listed in a service catalog. When a service call arrives to one of these teams, a performance-handling time may be logged or recorded, wherein that performance-handling time identifies a duration of time associated with the service call. In this example, historic data may be selected from this universe of data from certain teams, may be associated with one of the four activities, and may comprise handing times of tasks, wherein the handling times are organized as a function of which sub-activity of the selected one activity is associated with each task. Although not a requirement of the present invention, in this example, each logged handling time is associated with one service team, with one activity, and with one sub-activity.

Depending on business goals, an identified duration of time associated with a service call might comprise, but is not limited to: a time from when the call is answered until a team member resolves an issue reported by the call to the satisfaction of the caller; a time from when a call is retrieved from a call-waiting queue until a team member resolves the reported issue; or a time from when the call is placed in the queue until a team member first speaks to the user.

In other embodiments, a service organization may use methods of the present invention to track other performance parameters, such as customer satisfaction or a total duration of calendar time associated with multiple calls required to fully resolve a problem. In other embodiments, a service organization may perform tasks that are not triggered by an incoming user service call. Tasks may be initiated by predetermined maintenance, upgrade, or training schedules, by automatic environmental or systems alarms, or by user contact through other electronic or non-electronic media.

Choice, characterization, assignment, and organization of activities and sub-activities may be all or partly dependent upon business needs. In one example, a service organization might handle an activity “Support North American Communications Infrastructure” that comprises forty sub-activities that might in turn comprise classifications like: “Support Network-Backbone Application,” “Manage User IP Addresses,” “Manage Virtual-Machine Provisioning,” “Support Backup Services,” “Resolve Operating-System Conflicts,” or “Support Mail-Routing Services.”

In embodiments shown in FIG. 2, a method of time-value capturing (TVC), as known by those skilled in the art, is used to capture the universe of performance data. Each captured TVC sample identifies a duration of time required by a team member to complete a sub-activity, wherein the exact definition of sub-activity completion, as described above, may depend upon goals of the service organization. In other embodiments, the historic performance data may be captured by different methods or may derive from different sources.

In embodiments shown in FIG. 2, activities or services that may be performed by the service organization or by one or more teams comprised by the service organization may be listed in a “service catalog,” wherein each activity may be further broken down into sub-activities. In such embodiments, as is known to those skilled in the art, users may select an activity, sub-activity, or other service to request from a service organization by making a choice from such a listing. In other embodiments, a user may request service by an other method or mechanism.

In some embodiments, a service team of the service organization may not perform all activities listed in a service catalog. Choosing performance data associated with a subset of all activities listed in the catalog would thus, in such cases, retrieve data associated only with teams that perform an activity of the subset of activities.

In step 201, service teams that perform sub-activities of one or more desired activities are selected for evaluation by means of a random selection process. In embodiments described below, we describe a relatively simple example wherein teams are selected randomly from all teams that perform all sub-activities of a first activity. In this example, a number of teams is selected, such that the number is likely to be large enough to produce statistically meaningful results. This number may be based on an evaluation made by one skilled in the art of statistical analyses and possessed of business knowledge about the service organization.

In other embodiments, this choice of number of teams may be based on other considerations specific to the needs of the business. In all cases, the actual selection process, whereby specific teams are selected from a domain of all qualifying teams, is performed randomly. If the domain is not large enough to provide a desired number of teams, the method of the present invention cannot proceed.

In the example of FIG. 2, it has been determined by designers who implement the embodiment of FIG. 2 that at least 15 teams or skill groups must be selected in order to produce statistically meaningful results. In other cases wherein, for example, skill groups might on average comprise more or fewer team members, a different minimum number of teams or skill groups might be selected.

At the conclusion of step 201 of this exemplary embodiment of the present invention, a processor or other entity will have selected sets of service logs that in aggregate comprise at least historic TVC performance data for a set of skill groups, wherein those skill groups have been selected randomly from a subset of service teams of a service organization, and wherein a service team of that subset of service teams performs one or more sub-activities of a first activity listed in a service catalog.

In step 203, the processor or other entity sorts the aggregated performance data collected from the randomly selected skill groups in step 201, and then filters out data associated with service tasks deemed to cause a distorting effect. This deeming is in part a function of implementation-dependent considerations known to those with expert knowledge of an operation of the service organization, of the service catalog, of the selected activities or sub-activities, or of the selected service teams or skill groups.

In the example of FIG. 2, the sorting might be performed such that the captured time and performance data is organized into a set of groups that each identify TVC data for tasks related to one sub-activity of the first activity. This sorting may be performed by automated means, such as by computer software that sorts as a function of a value of a sub-activity identifier associated with each record.

In some embodiments, the filtering might be performed such that the captured time and performance records associated with certain classes of activities that the service organization does not wish to track are discarded. This filtering may be performed by automated means, such as by computer software and, in the example described here, such automated filtering may be performed by identifying a task identifier associated with each record. In this example, a value of a record's task identifier might associate that record with a type of task, but might not associate the record with a class of activity or sub-activity.

In the current example, a standard implementation of a TVC-automated logging function might thus identify a record associated with an unplanned service interruption or a service-quality reduction incident with a “PRBLM” identifier; might identify a user's service-request record with a “SRQ” identifier; might identify a change-ticket record (ordering a change to an IT-environment characteristic, such as a hardware move or software installation) with a “CHNG”; are change tickets; or might identify a maintenance record (to install a patch or run a diagnostic) with a “MNT” identifier.

In such an example, PRBLM and SRQ records might then retained because they represent tasks that require team-member time to resolve a technical problem that affects users; but “CHNG” and “MNT” records might be filtered out because they are not associated with time required to resolve unscheduled service problems. This determination of whether to retain or discard a record based on its task-type identifier might be independent of the type of sub-activity and activity associated with the record.

Similarly, records that require approvals or other customer intervention, such as routine updates and patch installations might be discarded because time spent on such tasks are not clearly attributable only to service-team members. An other type of record that might be discarded is a record associated with a task that was interrupted prior to completion, thus failing to provide an accurate estimate of a duration of time needed to fully resolve an issue. Finally, records identified by the service organization as being irrelevant to the goals of the benchmarking effort, such as associated with administrative or training tasks, might also be discarded.

Other selection criteria are possible within the scope of the present invention, wherein those criteria may be determined by those skilled in the art of service-organization management, statistical analysis, information technology, business intelligence, or related fields, or by those who possess expert knowledge of the service organization or its clients.

In some embodiments, this filtering may be performed by automated means, such as by computer software and, in the example described here, such automated filtering may be performed by identifying a task identifier associated with each record. A standard implementation of a TVC-automated logging function might, for example, identify a record associated with an unplanned partial service interruption or a service-quality reduction incident with a “PRBLM” identifier or might identify a service-request record with a “SRQ” identifier.

At the conclusion of step 203, the processor will have created a set of historic performance records that identify the durations of time consumed by the skill groups randomly selected in step 201 in order to perform sub-activities of the first activity. These records will have been sorted by sub-activity and will have been filtered to remove records associated with certain types of tasks that may bias aggregate performance figures.

Step 205 initiates an iterative procedure that comprises steps 205 through 217. Each iteration of this procedure determines a benchmark performance standard for one sub-activity of the first activity. At the conclusion of the last iteration of this procedure, the method of FIG. 2 will have determined a distinct benchmark for each sub-activity associated with the set of performance records assembled during step 203.

In step 207, the processor or other entity performs a first threshold determination of whether the set of records assembled during step 203 comprises enough samples associated with a current sub-activity (that is, a sub-activity being evaluated by the current iteration of the procedure of steps 207-217) to allow steps 209-215 to produce meaningful results.

This first threshold number of records may be determined by those skilled in the art of statistical analysis and by persons who possess expert knowledge of the service organization. In the example of FIG. 2, step 207 determines whether fewer than 100 records are associated with the current sub-activity. In other embodiments, this number may vary, as a function of implementation-dependent and business-dependent considerations, as described above.

If the procedure of step 207 identifies a sufficient number of records associated with the current sub-activity to produce a statistically meaningful benchmark standard for that sub-activity, the method of FIG. 2 continues with steps 209-215.

In step 209, the processor or other entity determines whether a number of the captured records associated with the current sub-activity that identify zero-duration times exceeds a second threshold value. This second threshold value may be determined by those skilled in the art of statistical analysis and by persons who possess expert knowledge of the service organization. In some embodiments, the second threshold may identify a proportion or percent of the total number of records selected in step 203, or of a subset of the total number of records selected in step 203, wherein records of the subset of records are associated with the current sub-activity.

In one example, this second threshold value may be set such that, if a total number of zero-duration records associated with the current sub-activity exceeds 10% of the total number of records associated with the current sub-activity, the the procedure of step 209 does not perform steps 213-215.

The determination of step 209 may be omitted in some embodiments, but may be included if the mechanism by which performance data is captured produces false zero-value records. An example of a false zero-value record may be a record that is generated by time-tracking systems that are unable to properly track activities of team member that perform more than one task at a time. In such cases, such a tracking system may correctly determine that a team member is performing multiple concurrent or simultaneous tasks and may create a time entry for each task. But it may be unable to identify which task to associate with each block of time.

Such time-logging systems thus allocate all time spent on any of the concurrent or simultaneous tasks to a single time record, and allocate zero time values to the time records associated with the other tasks. Such a practice may distort the results of the present method by improperly allocating time associated with a first sub-activity to a record associated with a second sub-activity.

Because it may be difficult to identify which records are associated with such concurrent or simultaneous tasks, and because the true division of time among those tasks can no longer be identified, methods of the present invention partially compensate for this distorting information by converting the zero-duration records in steps 213-215. But if the total number of records associated with a sub-activity is too large, even this partial compensation may be insufficient to preserve the integrity of any benchmark produced by this method.

Thus, if it is determined in step 209 that too many zero-duration record have been logged for the current sub-activity, the method of FIG. 2 skips steps 213-215 and instead executes the null branch of step 211. The current iteration of iterative procedure 207-217 then ends and a next iteration begins. If the current iteration had evaluated the last sub-activity of the first activity, the method of FIG. 2 ends. If other sub-activities of the first activity remain to be evaluated, the next iteration of the procedure of steps 207-217 begins.

If the procedure of step 209 identifies a sufficient number of non-zero records associated with the current sub-activity, the method of FIG. 2 continues with steps 213-215.

Step 213 replaces the zero-duration records associated with the current sub-activity with a non-zero value chosen to mitigate a biasing effect of inaccurately recorded zero-duration performance times. The manner of replacement may be a function of business goals and of other implementation-dependent factors, and may be determined by those skilled in the art of statistical modeling, statistical analysis, business intelligence, information technology, customer service, or related fields; or may be determined by those with expert knowledge of the operation of the service organization or of its skill groups.

In the current example, each zero-timing record is adjusted to identify a random duration of time chosen within a range between 0 and 1 time unit, wherein a time unit represents the smallest division of time that is tracked by the time-capture mechanism. Adding a smaller unit of non-zero time may provide less distortion to the time entries by providing less of an artificial increase to the total amount of time allocated to a sub-activity, but will still prevent the inclusion of zero time entries in further calculations. In other examples, other methods may be used to identify substitute values used to adjust zero-timing records.

In step 215, the processor or other entity computes a benchmark standard value associated with the current sub-activity. This computation is a function of a median value of the captured records associated with the sub-activity in step 201, filtered to remove undesired values in step 203, identified as comprising enough nonzero samples to provide statistically meaningful results in steps 207 and 209, and adjusted to ensure that the remaining samples fall into a range that has a nonzero lower limit.

In the embodiment of FIG. 2 shown herein, step 215 comprises identifying a benchmark value equal to a median value of this set of samples associated with the current sub-activity. In other embodiments, a benchmark may be a different function of the median value, such as a scaled or weighted median value or a more complex value that is a function of additional parameters, of which the median is one.

If the procedure of step 207 had identified an insufficient number of records associated with the current sub-activity to produce a statistically meaningful benchmark standard for that sub-activity, the method of FIG. 2 skips steps 209-215 and instead executes the null branch of step 217.

The current iteration of the iterative procedure of steps 207-217 then ends and a next iteration begins. If the current iteration had evaluated the last sub-activity under consideration, the method of FIG. 2 ends. If other sub-activities remain to be evaluated, the next iteration of the procedure of steps 207-217 begins in order to evaluate the next sub-activity of the first activity.

At the conclusion of the last iteration of the method of FIG. 2, embodiments of the present invention will have derived an initial set of benchmark values, each of which is associated with a sub-activity of the first activity. Each benchmark of the initial set will have been based on a median value of a statistically significant set of historic performance data associated with the sub-activity, wherein that data set will have been filtered to remove biasing or otherwise distorting samples.

In some embodiments, the method of FIG. 2 may be repeated iteratively, increasing the number of skill groups or of performance-data records selected in step 201 until a sufficient number of nonzero performance records are obtained to produce an acceptable, optimal, or maximum number of statistically meaningful benchmarks.

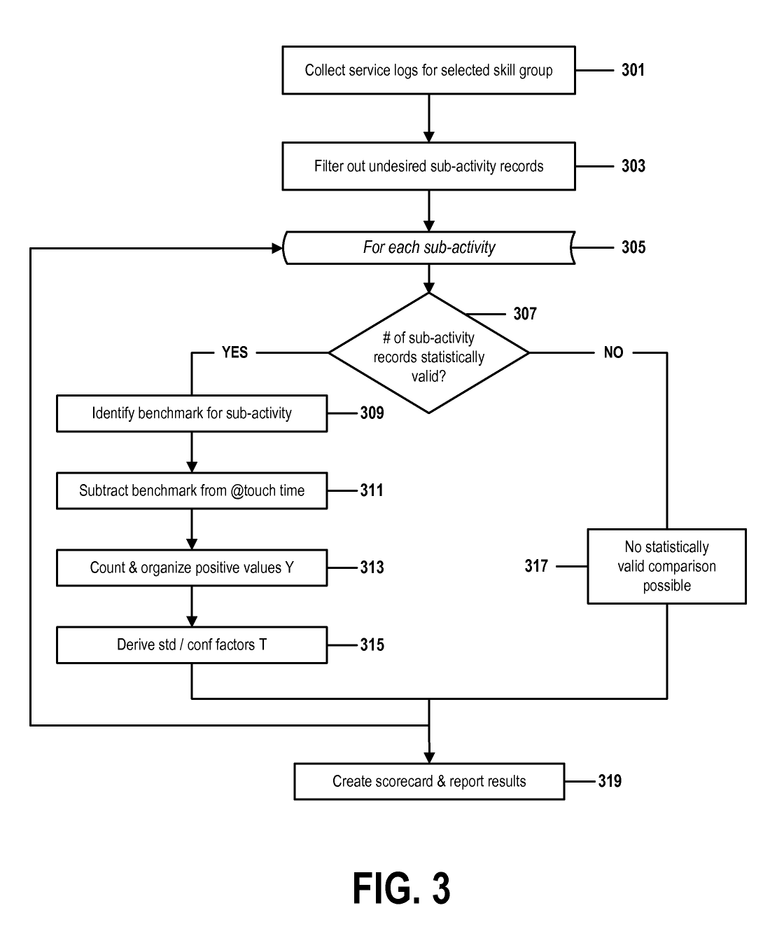

FIG. 3 is a flow chart showing an embodiment of the method of the present invention that uses a median-based benchmark, developed by the method of FIG. 2, in order to benchmark performance of a skill group or other type of service team of a service organization. FIG. 3 comprises steps 301-319.

The method of FIG. 3 occurs after one or more benchmark standards have been derived for at least one sub-activity of the first activity, in accordance with the method of FIG. 2. The method of FIG. 3 uses these benchmarks to characterize performance of a skill group or service team of the service organization (“the selected skill group”).

In step 301, a processor or entity selects the skill group to be benchmarked from a set of all skill groups or service teams of the service organization. In some embodiments, the selected skill group is distinct from any skill group or other type of service team selected in step 201 in order to derive the benchmark standards produced by the method of FIG. 2.

The processor or other entity next identifies and selects historic performance records associated with the selected skill group, wherein the selected records comprise information of a type similar to that of records selected in step 201.

In step 303, if the method of FIG. 3 is to be applied only to sub-activities of the first activity, the processor or other entity discards selected records that are not associated with sub-activities of the first activity. The processor or other entity then sorts the remaining records by sub-activity and filters out undesired records by means of steps similar to those of step 203. In the example of FIG. 2, for example, the processor might select only TVC-logged records associated with PRBLM or SRQ identifiers.

In some embodiments, filtering, sorting, or discarding may be performed in order to identify records associated with zero-duration times, in order to facilitate a decision of whether sufficient records remain when zero-duration records are discarded. These and similar procedures may be performed by methods similar to those of step 209 of FIG. 2.

In step 303, the processor or other entity may thus determine whether a number of the captured records associated with the current sub-activity and with the selected skill group that identify zero-duration times exceeds a fourth threshold value. This fourth threshold value may be determined by those skilled in the art of statistical analysis and by persons who possess expert knowledge of the service organization. In some embodiments, the fourth threshold may identify a proportion or percent of a total number of records identified in step 303.

In one example, a fourth threshold value may be selected such that, if a total number of zero-duration records associated with the current sub-activity and with the selected skill group exceeds 10% of the total number of records identified in step 303, the procedure of step 309 does not perform steps 309-315 for the current sub-activity.

At the conclusion of step 303, the remaining historic performance-data records will be organized into one or more groups, wherein a first group of the one or more groups comprises records that each identify a performance of the skill group when performing a task associated with a first sub-activity, and wherein the task satisfies filter criteria similar to those described in step 203.

Step 305 initiates an iterative procedure that comprises steps 305 through 317. Each iteration of this procedure analyzes the selected skill group's performance when performing tasks associated with a one sub-activity (the “current sub-activity” of the iteration) of the set of sub-activities comprised by the first activity. This analyzing comprises comparisons of the group's performance against a benchmark associated with the current sub-activity that was derived by the method of FIG. 2.

At the conclusion of the last iteration of this procedure, the method of FIG. 3 will have performed a set of analyses of the selected skill group's performances as a function of a corresponding benchmark, wherein each analysis and its corresponding benchmark are associated with one sub-activity comprised by the first activity.

In step 307, the processor or other entity performs a third threshold determination to determine whether a number of filtered records identified during step 303 as being associated with the current sub-activity comprises enough to allow the procedure of steps 309-315 to produce meaningful results.

This third threshold determination may be performed by methods known by those skilled in the art of statistical analysis and by persons who possess expert knowledge of the service organization. In the specific example of FIG. 3, step 307 may determine whether fewer than 10 records are associated with the current sub-activity and with the selected skill group. In other embodiments, this number may vary, as a function of implementation-dependent and business-dependent considerations, as described above.

If the procedure of step 307 identifies a sufficient number of records associated with the current sub-activity and selected skill group for steps 309-315 to produce a statistically meaningful result, the method of FIG. 3 continues with steps 309-315.

In step 309, the processor or other entity identifies a benchmark standard derived by the method of FIG. 2, wherein the identified benchmark is associated with the current sub-activity. If the method of FIG. 2 could not derive a benchmark for the current sub-activity, then the current iteration of the iterative procedure of steps 305-315 cannot proceed and the method of FIG. 3 proceeds with a next iteration of the iterative procedure or, if all sub-activities of the first activity have been analyzed, instead proceeds to step 319.

In step 311, the processor or other entity subtracts the value of the benchmark standard selected in step 309 from each “touch time” of each record of a subset of the set of records filtered in step 303, wherein each record of the subset is associated with the current sub-activity. Here, the term “touch time” refers to a duration of time identified by a captured record as the duration of time required by a team member of the selected skill group to complete a task associated with the captured record.

In one example, consider a benchmark associated with the current sub-activity that specifies a 10.0 hours standard for performing a task associated with the current sub-activity. If three records that respectively identify previous touch times of tasks associated the current sub-activity of 12.2 hours, 20.2 hours, and 9 hours, step 211 will reduce each of those touch times by 10.0 hours, yielding normalized values of: 2.2 hours, 10.2 hours, and −1.0 hours.

At the conclusion of step 311, each record of the subset of filtered records that is associated with the current sub-activity and with the selected skill group will have been normalized such that it identifies a difference between its original touch time and the time identified by the benchmark value associated with the current sub-activity.

In step 313 the processor or other entity then counts the number of positive normalized touch time values of the current sub-activity records, as derived in step 311. For illustrative purposes, this number of positive values is referred to as Y.

In step 315, the computation continues with the derivation of standardized confirmation variables that characterize an overall performance of the selected skill group when performing the current sub-activity. This computation comprises:
a. Identifying a variable n as a total number of filtered sub-activity records being evaluated by this iteration of the iterative procedure of steps 307-317.
b. Identifying a variable m as a first estimate of a number of positive normalized touch times determined in step 311, whereas m is equal to n/2. This first estimate may be in part a function of the fact that the benchmark for this sub-activity was derived by the method of FIG. 2 as a function of a median value of previous touch times.
c. Identifying a binomial standard deviation s as a of a distribution of a number of positive normalized touch times as a function of the total number n of filtered sub-activity records being evaluated, wherein s is equal to a square root of (n/4).
d. Calculating a test statistic T that represents a degree of deviation from the benchmark value, wherein: T=(Y−m)/s. Here, a value of T may identify a confidence factor that indicates whether the selected skill group significantly deviates from the benchmark as a function of comparing the value of T to a threshold value of risk that may be selected by the user. In some embodiments, an absolute value (or magnitude) of a calculated value of T greater than a selected threshold risk value might thus indicate that a performance of the selected skill group significantly deviates from the benchmark standard when performing tasks associated with the current sub-activity. In a first example, a selected threshold risk value of T=2.12 might indicate that the service organization considers a 99% confidence that the skill group's evaluated performance falls within an acceptable range of performance to be acceptable. If the calculated value of T is greater than 2.12, the group would thus be considered to have an unacceptably large risk of deviating from the benchmark standard when performing tasks associated with the current sub-activity. Similarly, in another example, a selected threshold risk value of T=2.12 might indicate that the service organization considers a 95% confidence that the skill group's evaluated performance falls within an acceptable range of performance to be acceptable. If the calculated value of T is greater than 1.96, the group thus would be considered to have an unacceptably large risk of deviating from the benchmark standard when performing tasks associated with the current sub-activity.

At the conclusion of step 315, the method of FIG. 3 will have generated a T confidence factor associated with the selected skill group's performance when performing tasks associated with the current sub-activity. In some embodiments, an absolute value of T greater than a fifth threshold value (such as the 1.96 value cited in the example above) might indicate that the skill group has significantly deviated from the median benchmark for performance associated with the current sub-activity. In some embodiments, a negative value of T may represent that the skill group has outperformed in relation to the benchmark when performing tasks related to the current sub-activity, and a positive value of T may further represent that the skill group has underperformed in relation to the benchmark when performing tasks related to the current sub-activity.

If the procedure of step 307 had identified an insufficient number of records associated with the current sub-activity and selected skill group to produce a statistically meaningful result, the method of FIG. 3 skips steps 309-315 and instead executes the null branch of step 317.

The current iteration of the iterative procedure of steps 307-317 would then end and a next iteration begins. If the current iteration had evaluated the last sub-activity under consideration, then the method of FIG. 3 continues with step 319. If other sub-activities remain to be evaluated, the next iteration of the procedure of steps 307-317 begins in order to evaluate the next sub-activity of the first activity.

At the conclusion of the last iteration of the iterative procedure of steps 307-317, the processor or other entity will have derived a value of T for each sub-activity of the first activity for which there is sufficient historic performance data to perform the derivation of steps 309-315. Each such value of T characterizes a performance of the selected skill group when performing one of the sub-activities of the first activity, wherein the characterization is a function of a benchmark standard identified by the method of FIG. 2 that is associated with the one of the sub-activities.

In step 319, the processor or other entity reports the results of the previous steps as a function of the T values identified by each iteration of step 315. The format, structure, presentation means, communications means, and other characteristics of the reporting are implementation-dependent and may be selected in accordance with methods and tools known to those skilled in the art or to those who possess expert knowledge of the service organization, the service catalog, or a client of the service organization. The results may be reported to an entity affiliated with the service organization, its parent business, its clients, or to other interested parties.

In one example, the results may be reported as a tabular or non-tabular “scorecard” that may comprise a list of sub-activities of the first activity, a benchmark value (as derived by the method of FIG. 2) for each sub-activity, and an actual median value of the selected skill group's performance of tasks associated with each sub-activity. Such a scorecard may further report other information deemed relevant to the service organization or its clients, such as a number of nonzero captured historic time records of the skill group for each sub-activity or a number of zero captured historic time records of the skill group for each sub-activity.

Furthermore, each sub-activity's records may be color-coded as a function of the sub-activity's corresponding T value to indicate characteristics of the skill group's performance of tasks associated with the sub-activity. Such characteristics may comprise: performance within a specified number of standard deviations from a corresponding benchmark value; performance that outperforms the corresponding benchmark value that falls outside the specified number of standard deviations; or performance that underperforms the corresponding benchmark value that falls outside the specified number of standard deviations.

Scorecards and other reporting mechanisms produced by the method of FIG. 3 may further present management recommendations based on T values. Such recommendations may include diagnostic or proscriptive measures when a skill group significantly underperforms, or may advise management to determine whether a skill group's ability to significantly outperform a benchmark suggests revisions to current best-practices procedures.

What is claimed is:

1. A method for benchmarking performance of a service organization, the method comprising:
a processor of a computer system selecting a set of service teams of a service organization, wherein each team of the set of service teams performs a plurality of service tasks, wherein a first task of the plurality of tasks is associated with a first sub-activity of a set of sub-activities and with a first task type of a set of task types;
the processor receiving a first set of performance records, wherein a first record of the first set of performance records comprises a first performance time that identifies a first duration of time needed by a first service team of the set of service teams to perform the first task;
the processor organizing the first set of performance records into a plurality of subsets of records, such that a first subset of records of the plurality of subsets comprises records that are associated with the first sub-activity;
the processor specifying a first benchmark of a first sub-activity of the first set of sub-activities as a function of a median value of all performance times comprised by the first subset of records.

2. The method of claim 1, further comprising:
the processor determining whether the first task type is associated with a desirable task type of the set of task types or an undesirable task type of the set of task types, wherein the desirable task type is selected from a group comprising: an unplanned service interruption, a reported reduction in quality of service, or a user service request; and wherein the undesirable task type is selected from a group comprising: a planned change of a user configuration and a scheduled maintenance operation.

3. The method of claim 2, further comprising:
the processor concluding that the first task type is an undesirable task type; and
the processor discarding the first record as a function of the concluding.

4. The method of claim 1, further comprising:
the processor confirming that a number of records comprised by the first subset of records exceeds a minimum threshold value.

5. The method of claim 4, wherein the minimum threshold value is derived as a function of criteria selected from a group comprising: the number of records comprised by the first subset; and a number of records comprised by the first subset that identify a nonzero performance time.

6. The method of claim 1, further comprising:
the processor identifying that the first performance time is equal to zero and setting the first performance time to a substituted nonzero value.

7. The method of claim 6, wherein the substituted nonzero value is selected as a random value between zero and one.

8. The method of claim 6, further comprising:
the processor identifying a smallest received nonzero performance time comprised by a record of the first set of performance records; and
the processor selecting the substituted nonzero value as a random nonzero value between zero and the smallest received nonzero performance time.

9. The method of claim 1, wherein the set of service teams is selected randomly from a set of all teams comprised by the service organization.

10. The method of claim 1, further comprising:
the processor identifying a second service team of the service organization, wherein the second service team is not comprised by the set of service teams;
the processor accepting a second set of performance records, wherein a second record of the second set of performance records comprises a second performance time that identifies a second duration of time needed by the second service team of the set of service teams to perform a second task, and wherein the second task was associated with the first sub-activity and with a second task type of a set of task types;
the processor arranging the second set of performance records into a plurality of subsets of records, such that a second subset of records of the plurality of subsets comprises records that are associated with the first sub-activity;
the processor determining a first count value Y of the first sub-activity and of the second service team, wherein the first count value identifies a number of performance times comprised by records of the second subset that are larger than the first benchmark;
the processor counting a first count estimate Est that is equal to one-half the total number of performance times comprised by records of the second subset;
the processor deriving a standardized variable SV of the second group equal to one-half of the first count value Y;
the processor computing a first binomial standard deviation of the distribution of the first count value SD as a square root of an intermediate quantity, wherein the intermediate quantity equals the first count value divided by four;
the processor calculating a first deviation of the second service team's performance for the first sub-activity as T=(Y−Est)/SD.

11. The method of claim 10, further comprising:
the processor reporting a service quality of the second service team as a function of T, wherein the service quality is selected from a group comprising: underperforming, outperforming, and acceptable.

12. The method of claim 11, wherein the second service team is identified as underperforming if T is greater than a maximum deviation threshold value, wherein the second service team is identified as outperforming if T is less than a minimum deviation threshold value, and wherein the second service team is identified as acceptable if an absolute value of T is less than the maximum deviation threshold value.

13. The method of claim 10, further comprising:
the processor concluding that the second task type is an undesirable task type; and
the processor discarding the second record as a function of the concluding.

14. The method of claim 10, further comprising:
the processor confirming that a number of records comprised by the second subset of records exceeds a minimum threshold value.

15. The method of claim 1, further comprising providing at least one support service for at least one of creating, integrating, hosting, maintaining, and deploying computer-readable program code in the computer system, wherein the computer-readable program code in combination with the computer system is configured to implement the selecting, receiving, organizing, and specifying.

16. The method of claim 10, further comprising providing at least one support service for at least one of creating, integrating, hosting, maintaining, and deploying computer-readable program code in the computer system, wherein the computer-readable program code in combination with the computer system is configured to implement the selecting, receiving, organizing, specifying, identifying, arranging, determining, counting, deriving, computing, and calculating.

17. A computer program product, comprising a computer-readable hardware storage device having a computer-readable program code stored therein, the program code configured to be executed by a processor of a computer system to implement a method for benchmarking performance of a service organization, the method comprising:
the processor randomly selecting a set of service teams of a service organization, wherein each team of the set of service teams performs a plurality of service tasks, wherein a first task of the plurality of tasks is associated with a first sub-activity of a set of sub-activities and with a first task type of a set of task types;
the processor receiving a first set of performance records, wherein a first record of the first set of performance records comprises a first performance time that identifies a first duration of time needed by a first service team of the set of service teams to perform the first task;
the processor organizing the first set of performance records into a plurality of subsets of records, such that a first subset of records of the plurality of subsets comprises records that are associated with the first sub-activity;
the processor specifying a first benchmark of a first sub-activity of the first set of sub-activities as a function of a median value of all performance times comprised by the first subset of records.

18. The computer program product of claim 17, further comprising:
the processor identifying a second service team of the service organization, wherein the second service team is not comprised by the set of service teams;
the processor accepting a second set of performance records, wherein a second record of the second set of performance records comprises a second performance time that identifies a second duration of time needed by the second service team of the set of service teams to perform a second task, and wherein the second task was associated with the first sub-activity and with a second task type of a set of task types;
the processor arranging the second set of performance records into a plurality of subsets of records, such that a second subset of records of the plurality of subsets comprises records that are associated with the first sub-activity;
the processor determining a first count value Y of the first sub-activity and of the second service team, wherein the first count value identifies a number of performance times comprised by records of the second subset that are larger than the first benchmark;
the processor counting a first count estimate Est that is equal to one-half the total number of performance times comprised by records of the second subset;
the processor deriving a standardized variable SV of the second group equal to one-half of the first count value Y;
the processor computing a first binomial standard deviation of the distribution of the first count value SD as a square root of an intermediate quantity, wherein the intermediate quantity equals the first count value divided by four;
the processor calculating a first deviation of the second service team's performance for the first sub-activity as T=(Y−Est)/SD.

19. A computer system comprising a processor, a memory coupled to the processor, and a computer-readable hardware storage device coupled to the processor, the storage device containing program code configured to be run by the processor via the memory to implement a method for benchmarking performance of a service organization, the method comprising:
the processor randomly selecting a set of service teams of a service organization, wherein each team of the set of service teams performs a plurality of service tasks, wherein a first task of the plurality of tasks is associated with a first sub-activity of a set of sub-activities and with a first task type of a set of task types;
the processor receiving a first set of performance records, wherein a first record of the first set of performance records comprises a first performance time that identifies a first duration of time needed by a first service team of the set of service teams to perform the first task;
the processor organizing the first set of performance records into a plurality of subsets of records, such that a first subset of records of the plurality of subsets comprises records that are associated with the first sub-activity;
the processor specifying a first benchmark of a first sub-activity of the first set of sub-activities as a function of a median value of all performance times comprised by the first subset of records.

20. The computer system of claim 19, further comprising:
the processor identifying a second service team of the service organization, wherein the second service team is not comprised by the set of service teams;
the processor accepting a second set of performance records, wherein a second record of the second set of performance records comprises a second performance time that identifies a second duration of time needed by the second service team of the set of service teams to perform a second task, and wherein the second task was associated with the first sub-activity and with a second task type of a set of task types;
the processor arranging the second set of performance records into a plurality of subsets of records, such that a second subset of records of the plurality of subsets comprises records that are associated with the first sub-activity;
the processor determining a first count value Y of the first sub-activity and of the second service team, wherein the first count value identifies a number of performance times comprised by records of the second subset that are larger than the first benchmark;
the processor counting a first count estimate Est that is equal to one-half the total number of performance times comprised by records of the second subset;
the processor deriving a standardized variable SV of the second group equal to one-half of the first count value Y;
the processor computing a first binomial standard deviation of the distribution of the first count value SD as a square root of an intermediate quantity, wherein the intermediate quantity equals the first count value divided by four;
the processor calculating a first deviation of the second service team's performance for the first sub-activity as T=(Y−Est)/SD.
